(19) United States
(12) Patent Application Publication
(10) Pub. No.: US 2007/0174408 A1
(43) Pub. Date: Jul. 26, 2007

(54) Filtering unnecessary chat artifacts from persistent chats

(75) Inventors: Christopher J. Paul, Durham, NC (US); Patrick G. McGowan, Chapel Hill, NC (US); Jeremy G. Perry, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/340,388

(22) Filed: Jan. 26, 2006

(51) Int. Cl. G06F 15/16

(52) U.S. Cl. 709/207

(57) ABSTRACT

The present invention provides for the filtering of unnecessary chat artifacts (e.g., “small talk”) from persistent chats. A method in accordance with an embodiment of the present invention includes: sending an instant message; and selectively including the instant message in a persistent chat.

### BACKGROUND OF THE INVENTION

1. Field of the Invention

The present invention generally relates to instant messaging, and more specifically relates to the filtering of unnecessary chat artifacts (e.g., “small talk”) from persistent chats.

2. Related Art

Instant messaging (IM), also commonly referred to as “chatting,” serves many purposes in business today. IM can be used to conduct formal business as well as for less formal communications. Generally, there are two types of chats: 1) non-persistent chats which “go away” at the end of a chat session; and 2) persistent chats which live on after a chat session has ended, often in the form of a document or discussion thread.

A persistent chat often includes unnecessary chat artifacts (e.g., comments, messages and/or message threads) that are irrelevant to the main topic(s) of discussion. These chat artifacts can be fairly lengthy, taking up a large amount of storage space, and can obfuscate the main topic of discussion of the persistent chat.

### SUMMARY OF THE INVENTION

The present invention allows a user to filter unnecessary chat artifacts from persistent chats.

A first aspect of the present invention is directed to a method for filtering unnecessary chat artifacts from a persistent chat, comprising: sending an instant message; and selectively including the instant message in a persistent chat.

A second aspect of the present invention is directed to a system for filtering unnecessary chat artifacts from a persistent chat, comprising: an instant messaging system for sending an instant message; and a system for selectively including the instant message in a persistent chat.

A third aspect of the present invention is directed to a program product stored on a computer readable medium for filtering unnecessary chat artifacts from a persistent chat, the computer readable medium comprising program code for performing the steps of: sending an instant message; and selectively including the instant message in a persistent chat.

A fourth aspect of the present invention is directed to a method for deploying an application for filtering unnecessary chat artifacts from a persistent chat, comprising: providing a computer infrastructure being operable to: send an instant message; and selectively include the instant message in a persistent chat.

A fifth aspect of the present invention is directed to computer software embodied in a propagated signal for filtering unnecessary chat artifacts from a persistent chat, the computer software comprising instructions to cause a computer system to perform the functions of: sending an instant message; and selectively including the instant message in a persistent chat.

The illustrative aspects of the present invention are designed to solve the problems herein described and other problems not discussed

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative IM user interface for filtering unnecessary chat artifacts from a persistent chat in accordance with an embodiment of the present invention.

FIG. 2 depicts an illustrative IM user interface for filtering unnecessary chat artifacts from a persistent chat in accordance with another embodiment of the present invention.

FIG. 3 depicts an illustrative flow diagram of a process for filtering unnecessary chat artifacts from a persistent chat “on-the-fly” in accordance with an embodiment of the present invention.

FIG. 4 depicts an illustrative IM user interface for filtering unnecessary chat artifacts from a persistent chat in accordance with another embodiment of the present invention.

FIG. 5 depicts an illustrative flow diagram of a process for filtering unnecessary chat artifacts from a persistent chat in accordance with another embodiment of the present invention.

FIG. 6 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

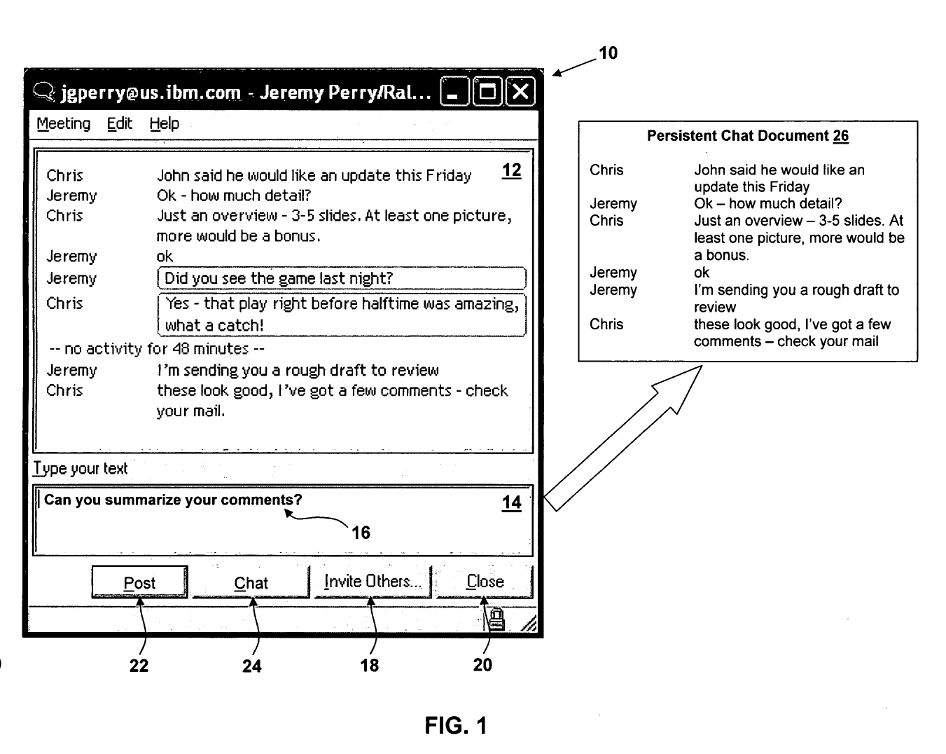

An illustrative IM user interface 10 for filtering unnecessary chat artifacts from a persistent chat in accordance with an embodiment of the present invention is depicted in FIG. 1. As shown, the IM user interface 10 generally includes a conversation pane 12 for displaying a history of a chat, a message pane 14 for displaying a message 16 to be sent to the other participants in the chat, an Invite Others button 18 for inviting other users to join the chat, and a Close button 20 for closing the IM interface 10.

The IM user interface 10 further includes the following selection mechanisms: a Post button 22 and a Chat button 24. When the user types a message 16 in the message pane 14 and subsequently actuates the Post button 22 (e.g., via a mouse click or keyboard shortcut), the message 16 is sent to the other participants in the chat and is included in a persistent chat and stored in a corresponding persistent chat document 26. However, when the user types a message 16 in the message pane 14 and subsequently actuates the Chat button 24 (e.g., via a mouse click or keyboard shortcut), the message 16 is sent to the other participants in the chat, but is not included in the persistent chat or stored with the corresponding persistent chat document 26. In this way, a user can select “on-the-fly” whether to include or exclude a chat artifact (e.g., message) as part of a persistent chat. It should be noted that the Send button (not shown) typically provided in an IM interface could be configured to perform the same function as the Post button 22 described herein. User interface selection mechanisms other than buttons could be used to provide the functionality of the Post button 22 and the Chat button 24.

The chat displayed in the conversation pane 12 of the IM user interface 10 is as follows, with the button (Post or Chat) used to send each message displayed in parenthesis after the message:
Chris John said he would like an update this Friday (Post)
Jeremy Ok—how much detail? (Post)
Chris Just an overview—3-5 slides. At least one picture, more would be a bonus. (Post)
Jeremy ok (Post)
Jeremy Did you see the game last night? (Chat)
Chris Yes—the play right before halftime was amazing, what a catch! (Chat)
Jeremy I'm sending you a rough draft to review (Post)
Chris these look good, I've got a few comments—check your mail (Post)
   The corresponding persistent chat document 26, which includes only those messages 16 sent using the Post button 22, is as follows:
Chris John said he would like an update this Friday
Jeremy Ok—how much detail?
Chris Just an overview—3-5 slides. At least one picture, more would be a bonus.
Jeremy ok
Jeremy I'm sending you a rough draft to review
Chris these look good, I've got a few comments—check your mail

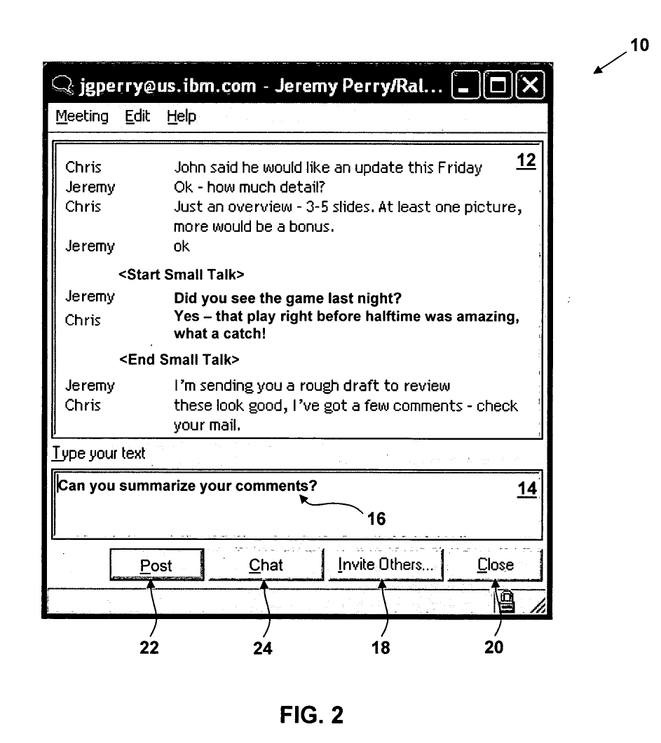

The messages in the conversation pane 12 of the IM user interface 10 can be displayed differently based on whether the Post button 22 or the Chat button 24 was used to send the message. In FIG. 1, for example, the messages sent using the Post button 22 are displayed without shading, while the messages sent using the Chat button 24 are displayed with a shaded background. Many other techniques for differentiating the messages in the conversation pane 12 of the IM user interface 10 are also possible. For example, messages sent using the Chat button 24 can be displayed in a different font, in a different format (e.g., bold, italics, underline), in a different color, etc, than messages sent using the Post button 22. Further, as shown in FIG. 2, messages such as <Start Small Talk>and <End Small Talk>, or other suitable indicia, could be used to delineate messages sent using the Post button 22 from messages sent using the Chat button 24.

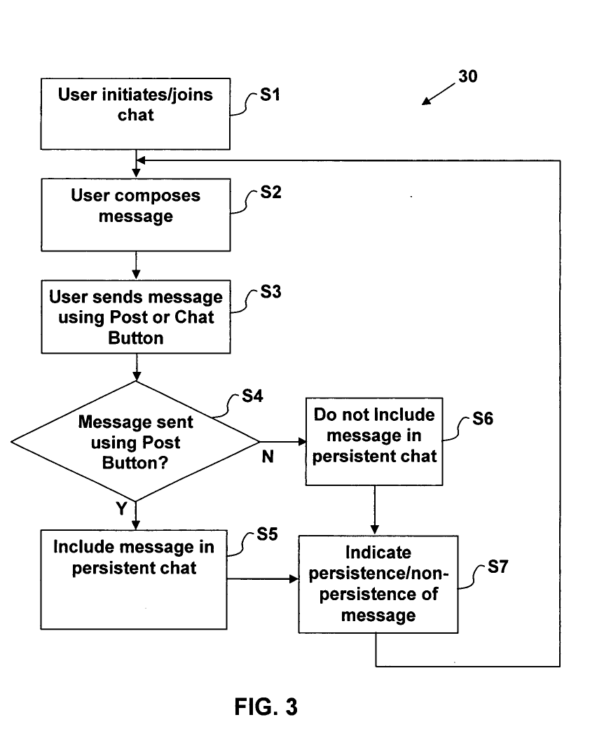

An illustrative flow diagram 30 of a process for filtering unnecessary chat artifacts from a persistent chat in accordance with an embodiment of the present invention is illustrated in FIG. 3. The flow diagram 30 is described below with regard to the IM user interface 10 depicted in FIG. 1. In step S1, a user initiates/joins a chat via an IM client. In step S2, the user composes a message 16 in the message pane 14 of the IM user interface 10. In step S3, the user sends the message 16 to the other participants in the chat using either the Post button 22 or the Chat button 24. If it is determined in step S4 that the Post button 22 was used to send the message 16 to the other participants in the chat, then the message 16 is included in the persistent chat in step S5. If it is determined in step S4 that the Chat button 22 was used to send the message 16 to the other participants in the chat, then the message 16 (i.e., chat artifact) is not included in (i.e., excluded from) the persistent chat in step S6. Flow passes from step S5 and S6 to step S7 where the persistence/non-persistence of the message 16 is displayed/indicated in some manner in the conversation pane 12 of the IM user interface 10. Flow then passes from step S7 back to step S2.

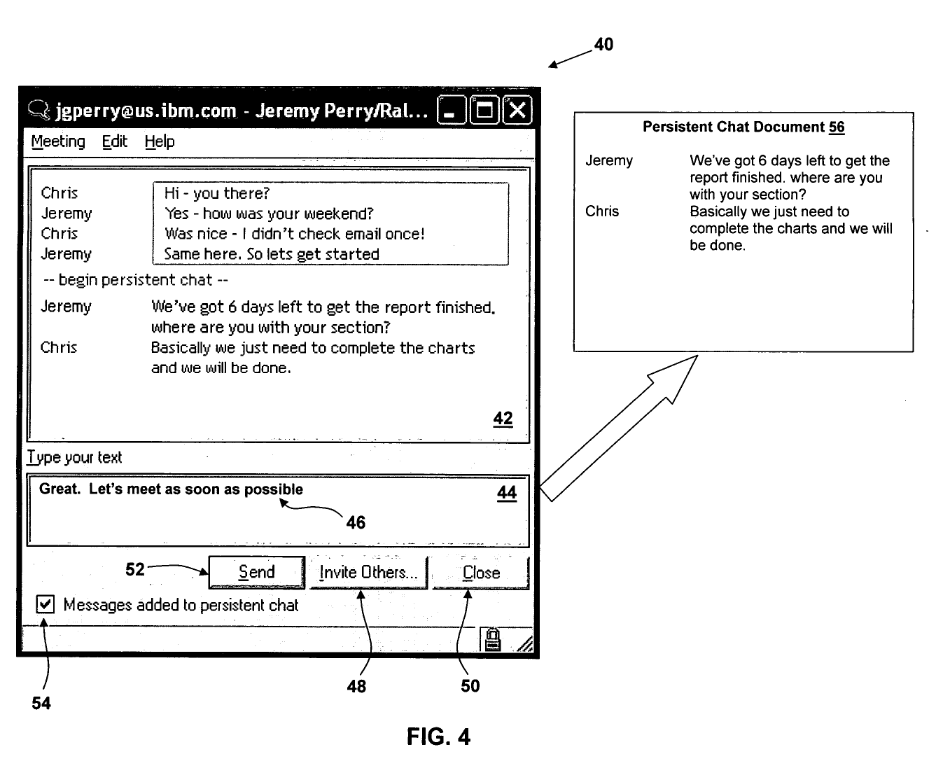

An illustrative IM user interface 40 for filtering unnecessary chat artifacts from a persistent chat in accordance with another embodiment of the present invention is depicted in FIG. 4. As shown, the IM user interface 40 generally includes a conversation pane 42 for displaying a history of a chat, a message pane 44 for displaying a message 46 to be sent to the other participants in the chat, an Invite Others button 48 for inviting other users to join the chat, and a Close button 50 for closing the IM interface 40.

The IM user interface 40 further includes a Send button 52 and a “Messages added to persistent chat” check box 54. When the user types a message 46 in the message pane 44 and subsequently actuates the Send button 52 (e.g., via a mouse click or keyboard shortcut) while the “Messages added to persistent chat” check box 54 is not checked, the message 46 is sent to the other participants in the chat, but is not included in the persistent chat or stored with the corresponding persistent chat document 56. However, when the user types a message 46 in the message pane 44 and subsequently actuates the Send button 52 (e.g., via a mouse click or keyboard shortcut) while the “Messages added to persistent chat” check box 54 is checked, the message 46 is sent to the other participants in the chat, and is included in the persistent chat and stored with the corresponding persistent chat document 56. In this way, a user can selectively “gate” (i.e., include or exclude) a chat artifact (e.g., message) to a persistent chat using the “Messages added to persistent chat” check box 54.

The “Messages added to persistent chat” check box 54 is only one of numerous available selection mechanisms that can be used to selectively “gate” a chat artifact (e.g., message) to a persistent chat. For example, a selection mechanism such as a radio button, drop-down list, keyboard shortcut, etc., could also be used.

The chat displayed in the conversation pane 42 of the IM user interface 40 is as follows, with the state of the “Messages added to persistent chat” check box 54 displayed in parenthesis after each message:
Chris Hi—you there? (not checked)
Jeremy Yes—how was your weekend? (not checked)
Chris Was nice—I didn't check email once! (not checked)
Jeremy Same here. So lets get started (not checked)
Jeremy We've got 6 days left to get the report finished. where are you with your section? (checked)
Chris Basically we just need to complete the charts and we will be done. (checked)
   The corresponding persistent chat document 56, which includes only those messages 46 sent using the Send button 52 while the “Messages added to persistent chat” check box 54 was checked, is as follows:
Jeremy We've got 6 days left to get the report finished. where are you with your section?
Chris Basically we just need to complete the charts and we will be done.

The messages in the conversation pane 42 of the IM user interface 40 can be displayed differently based on whether or not the “Messages added to persistent chat” check box 54 was checked when the Send button 52 was actuated. In FIG. 4, for example, the messages sent while the “Messages added to persistent chat” check box 54 was not checked are displayed with a shaded background, while the messages sent while the “Messages added to persistent chat” check box 54 was checked are displayed without shading.

Many other techniques for differentiating the messages in the conversation pane 42 of the IM user interface 40 are also possible. For example, messages sent while the “Messages added to persistent chat” check box 54 is not checked can be displayed in a different font, in a different format (e.g., bold, italics, underline), in a different color, etc., than messages sent while the “Messages added to persistent chat” check box 54 is checked. As further shown in FIG. 4, messages such as “—begin persistent chat—” and “—end persistent chat—,” or other suitable indicia, could also be used to delineate messages belonging to the persistent chat.

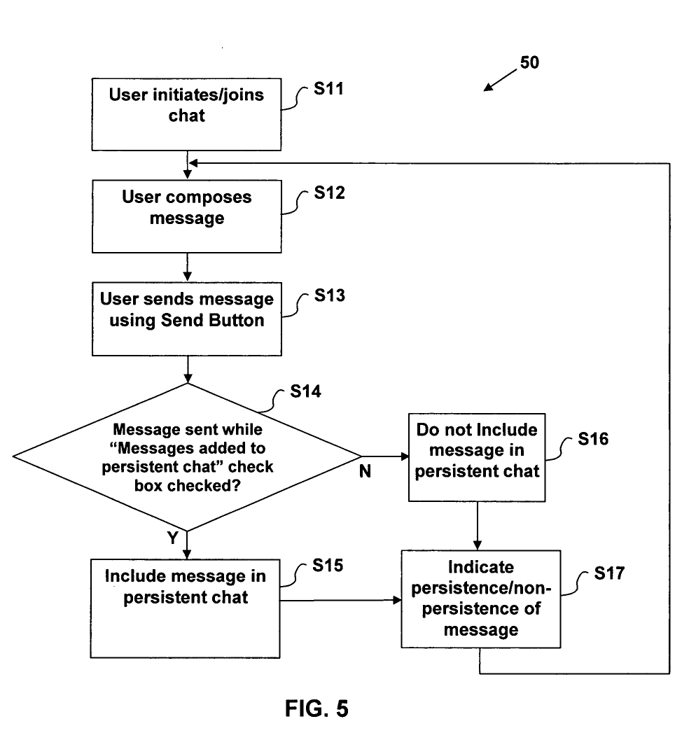

An illustrative flow diagram 60 of a process for filtering unnecessary chat artifacts from a persistent chat in accordance with this embodiment of the present invention is illustrated in FIG. 5. The flow diagram 60 is described below with regard to the IM user interface 40 depicted in FIG. 4. In step S11, a user initiates/joins a chat via an IM client. In step S12, the user composes a message 46 in the message pane 44 of the IM user interface 40. In step S13, the user sends the message 46 to the other participants in the chat by actuating the Send button 52. If it is determined in step S14 that the “Messages added to persistent chat” check box 54 was checked when the Send button 52 was actuated, then the message 46 is included in the persistent chat in step S15. If it is determined in step S14 that the that the “Messages added to persistent chat” check box 54 was not checked when the Send button 52 was actuated, then the message 46 (i.e., chat artifact) is not included (i.e., excluded) in the persistent chat in step S16. Flow passes from step S15 and S6 to step S17 where the persistence/non-persistence of the message 46 is displayed/indicated in some manner in the conversation pane 42 of the IM user interface 40. Flow then passes from step S17 back to step S12.

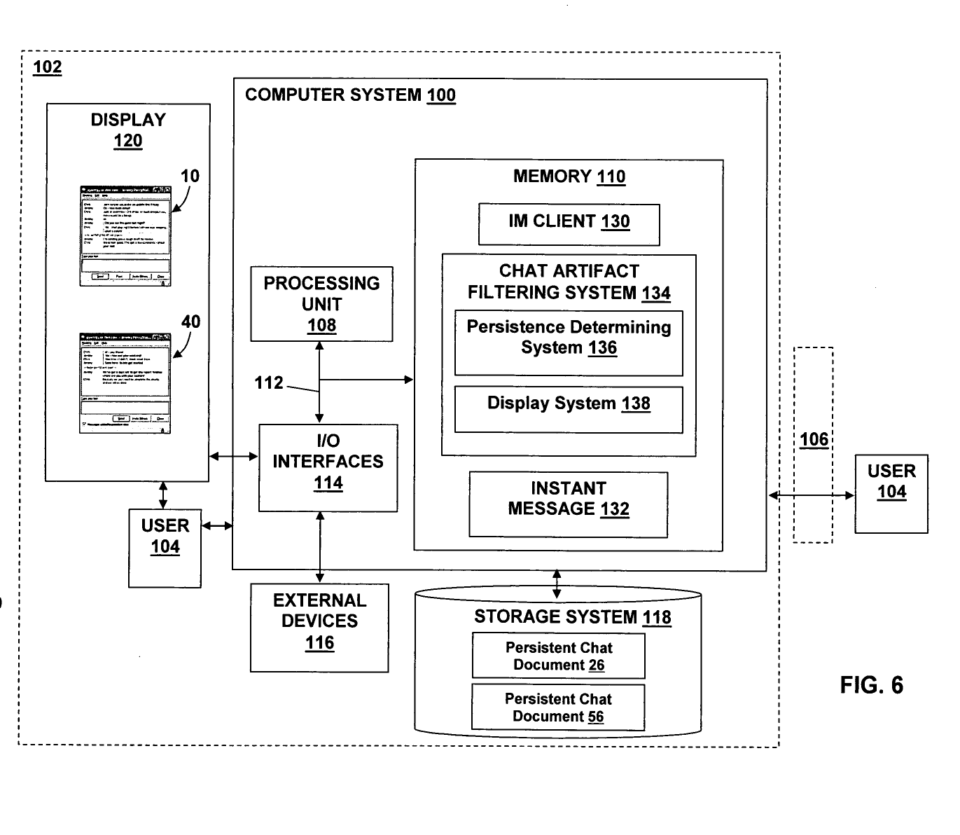

A computer system 100 for filtering unnecessary chat artifacts from a persistent chat in accordance with an embodiment of the present invention is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides filtering of unnecessary chat artifacts from a persistent chat in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as IM client 130 and chat artifact filtering system 134, stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an IM client 130 for generating and receiving instant messages 132 and a chat artifact filtering system 134 for filtering unnecessary chat artifacts from a persistent chat in accordance with the present invention, as described above.

In an embodiment of the present invention, the chat artifact filtering system 134 includes a persistence determining system 136 for determining whether the instant message 132 was sent using the Post button 22 (FIG. 1) or the Chat button 24 (FIG. 1) of the IM interface 10. If the Post button 22 was used to send the instant message 132, then the instant message 132 is included in the persistent chat and added to the corresponding persistent chat document 26, which may be stored in the storage system 118. On the other hand, if the Chat button 24 was used to send the instant message 132, then the instant message 132 is not included in the persistent chat and is not added to the corresponding persistent chat document 26. In another embodiment of the present invention, the persistence determining system 136 determines whether the instant message 132 was sent while the “Messages added to persistent chat” check box 54 (FIG. 4) of the IM interface 40 was checked. If so, then the instant message 132 is included in the persistent chat and added to the corresponding persistent chat document 56, which may be stored in the storage system 118. If not, then the instant message 132 is not included in the persistent chat and is not added to the corresponding persistent chat document 56. The chat artifact filtering system 132 can further include a display system 138 for providing the variable display functionality described above with regard to FIGS. 1, 2, and 4.

The present invention can be offered as a business method on a subscription or fee basis. For example, one or more components of the present invention can be created, maintained, supported, and/or deployed by a service provider that offers the functions described herein for customers. That is, a service provider can be used to provide a service for filtering unnecessary chat artifacts from a persistent chat, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system - is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for filtering unnecessary chat artifacts from a persistent chat, comprising:
sending an instant message; and
selectively including the instant message in a persistent chat.

2. The method of claim 1, further comprising:
adding the instant message to a persistent chat document if the instant message is included in the persistent chat.

3. The method of claim 2, further comprising:
sending a subsequent instant message; and
including the subsequent instant message in the persistent chat.

4. The method of claim 3, further comprising:
adding the subsequent instant message to the persistent chat document.

5. The method of claim 2, further comprising:
sending a subsequent instant message; and
selectively including the subsequent instant message in the persistent chat.

6. The method of claim 5, further comprising:
adding the subsequent instant message to the persistent chat document if the subsequent instant message is included in the persistent chat.

7. The method of claim 1, further comprising:
actuating a first selection mechanism to send the instant message and to include the instant message in the persistent chat; and
actuating a second selection mechanism to send the instant message without including the instant message in the persistent chat.

8. The method of claim 7, wherein the first and second selection mechanisms comprise buttons.

9. The method of claim 1, further comprising:
actuating, prior to sending the instant message, a selection mechanism to include the instant message in the persistent chat; and
continuing to include subsequently sent instant messages in the persistent chat until the selection mechanism is deactivated.

10. The method of claim 9, wherein the selection mechanism is selected from the group consisting of: a checkbox, a radio button, a drop-down list, and a keyboard shortcut.

11. A system for filtering unnecessary chat artifacts from a persistent chat, comprising:
an instant messaging system for sending an instant message; and
a system for selectively including the instant message in a persistent chat.

12. The system of claim 11, further comprising:
a system for adding the instant message to a persistent chat document if the instant message is included in the persistent chat.

13. The system of claim 12, further comprising:
a subsequent instant message sent by the instant messaging system; and
a system for including the subsequent instant message in the persistent chat.

14. The system of claim 13, further comprising:
a system for adding the subsequent instant message to the persistent chat document.

15. The system of claim 12, further comprising:
a subsequent instant message sent by the instant messaging system; and
a system for selectively including the subsequent instant message in the persistent chat.

16. The system of claim 15, further comprising:
a system for adding the subsequent instant message to the persistent chat document if the subsequent instant message is included in the persistent chat.

17. The system of claim 11, further comprising:
a first selection mechanism for sending the instant message and for including the instant message in the persistent chat; and
a second selection mechanism for sending the instant message without including the instant message in the persistent chat.

18. The system of claim 17, wherein the first and second selection mechanisms comprise buttons.

19. The system of claim 1 1, further comprising:
a selection mechanism, configured to be actuated prior to sending the instant message, for including the instant message in the persistent chat and for continuing to include subsequently sent instant messages in the persistent chat until the selection mechanism is deactivated.

20. The system of claim 19, wherein the selection mechanism is selected from the group consisting of: a checkbox, a radio button, a drop-down list, and a keyboard shortcut.

21. A program product stored on a computer readable medium for filtering unnecessary chat artifacts from a persistent chat, the computer readable medium comprising program code for performing the steps of:
sending an instant message; and
selectively including the instant message in a persistent chat.
